(19) United States
(12) Patent Application Publication
(10) Pub. No.: US 2007/0027712 A1
(43) Pub. Date: Feb. 1, 2007

(54) Combination prescription sample means and pad wallet

(76) Inventor: Joshua Lapsker, Christ Church (BB)

Correspondence Address: KLAUBER & JACKSON, 411 HACKENSACK AVENUE, HACKENSACK, NJ, 07601, US

(21) Appl. No.: 11/191,356

(22) Filed: Jul. 28, 2005

(51) Int. Cl. G06Q 10/00

(52) U.S. Cl. 705/2

(57) ABSTRACT

A prescription drug compliance and reusable discount system having enhanced patient privacy that provides incentives to patients to begin the taking of prescription medications, and incentives to a physician to utilize the system with their patients on a sustainable basis.

### BACKGROUND AND SUMMARY OF THE INVENTION

While prescription drugs are modern miracles in preserving and extending a person's life, not taking prescriptions as required (non-compliance) has become a major health problem. Additionally, people who may be only partially insured (such as the elderly), or wholly uninsured (such as lower income populations), or those who are too busy or forgetful in their daily lives to procure medications, are prone to discontinue or not to fill prescriptions as directed.

Non-compliance in prescription drug taking is putting an enormous strain on the health care system today. Estimates of cost to the United States economy range from 50 to as high as 100 billion dollars per year. It is estimated that 17 percent of all Emergency room visits are the direct result of a prescription drug misdirection (non-compliance). Other results of non-compliance include hospital and nursing home admissions, as well as lost wages and lower productivity. This non-compliance represents an unhealthy dynamic that costs both employers, insurance companies, and society at large greatly over time which insurance companies and others wish to reduce.

Currently no system exists to encourage or motivate a patient through financial incentives to comply with a drug prescription particularly in a way that ensures physician participation. Particularly, none of these systems provide both a realistic distribution means and an incentive for a given prescription medication to be taken. Moreover, no prior art systems address the difficulty of fostering compliance within the strict confines of medical confidentiality, such as that mandated under more recent legislation such as the Health Insurance Portability and Accountability Act (HIPAA).

As such, if a means were developed to motivate, instead of merely remind patients to take a prescribed medication, then compliance would be greatly enhanced. Any financial cost involved in such a system would be vastly outweighed by the cost savings for the care of chronically ill patients and the growing aged population.

Furthermore, a means is needed to provide for a truly convenient way of enlisting patients in such a system. Moreover, there is a need for such a means to be offered in such a way that it will easily integrate itself into the daily routine of the very physicians who will become the main point of distribution to patients in the inventive system. To this end, the present invention relates to the active promotion of the purchasing and taking of prescription drugs through an incentive-based compliance system. The system incorporates third party verification and remuneration stemming from an initial participation decision by a patient who has been influenced by the prospect of a free supply of medication when filing a given prescription. Pharmacy participation incentives, HIPAA-compliant medical verification, and financial incentives for all parties (patient, insurer, etc.), are additional benefits to this invention. The basis for such a system is an innovative prescription sample card that is likely to be consistently carried by physicians through the use of an innovative, convenient to carry wallet and is distributed by a treating physician to a patient at a time of treatment or prescribing.

### BRIEF DESCRIPTION OF THE DRAWINGS

FIGS. 1A, 1B and 1C are depictions of an exemplary prescription sample means and pad wallet in different stages of being open for use (1A and 1B) and being closed for convenient carrying (1C), as contemplated by the inventive system;

FIG. 2 is a flowchart detailing an exemplary process that might be employed in executing the inventive method and functions of the system.

### DETAILED DESCRIPTION OF THE DRAWINGS AND PREFERRED EMBODIMENTS

In its broadest aspect, the present invention provides for a method and a system distributed through a convenient, easy to carry compact foldable wallet that physicians will be inclined to carry with them in their daily practice. The wallet has two leaves (front and back) and a spine for connecting the leaves. Therein are the prescription sample means and the personalized pad. The prescription sample means comprises at least one sample means having a confidential identification number, and a solicitation means associated with each reusable discount means for soliciting a patient consent and patient information. When presented at a pharmacy for the filling of the prescription, the confidential (e.g. unique/HIPAA inspired) identification number will be forwarded by participating pharmacy associated with each fulfillment transaction, and a customer service processor will verify, authorize and remunerate as applicable. Verification as processed may be accomplished through a system such as that detailed in U.S. patent application Ser. Nos. 10/865,500 and 10/785,930, both of which are hereby incorporated by reference in their entirety.

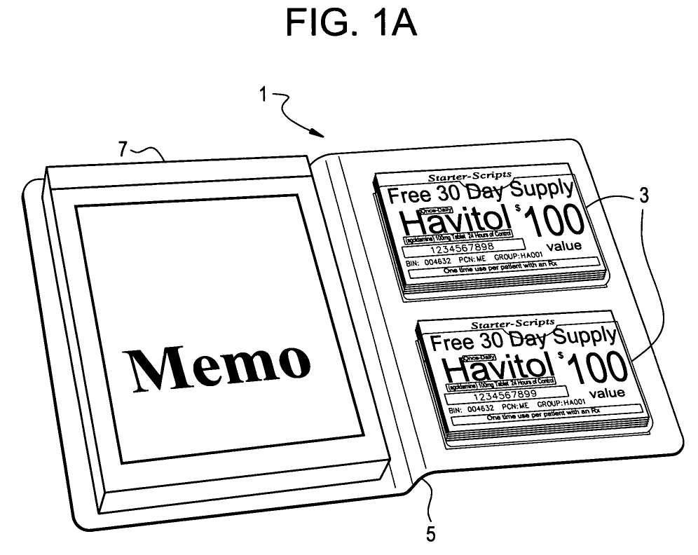

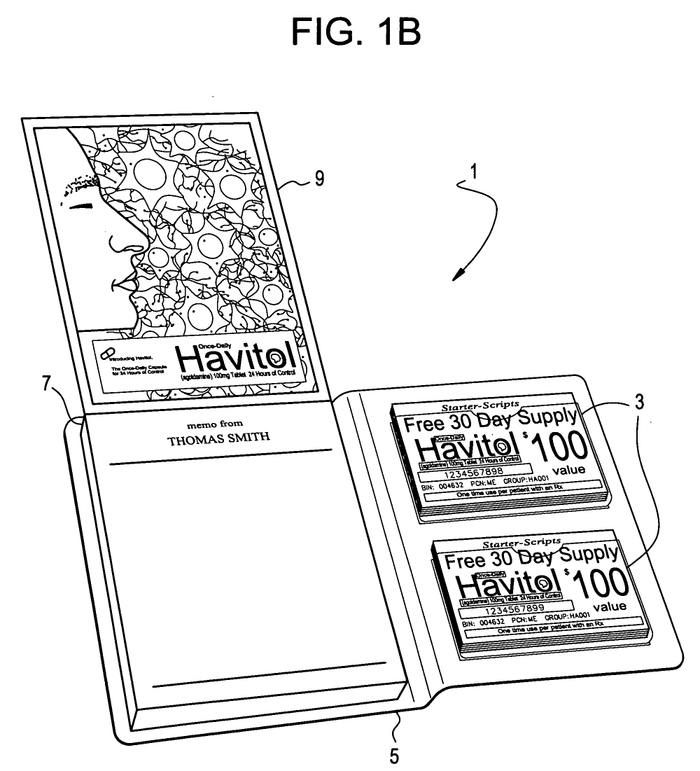

FIGS. 1A, 1B and 1C depict a prescription sample means, such as sample redemption card 3. FIGS. 1A and 1B depict the inventive prescription sample means and pad wallet 1 in open positions, with sample redemption cards 3 stacked in a pocket or pockets formed on one of said leaves, and said personalized physician pad 7 situated on another of said leaves. Although many variants of the prescription sample means 3 and personalized pad 7 may be envisioned, according to one embodiment, sample redemption card 3 will be a standard plastic (or paper) card, preferably having informational backing (not depicted), and will have printed product information, discount information, and a card identification means (e.g. a unique identifier or number, perhaps embodied by a bar code, smart chip, and/or magnetic stripe, etc. but most preferably, simply embossed or typed on the card). Such a unique identifier will be one of the preferred ways of activating and tracking the discount card usage and reimbursement recorded to usage thereof. Where the unique identifier, is for example, a bar code, such activation and subsequent card usage may be tracked by the use of a common bar code scanner device well known in the art of retailing and cash register technologies. However, in order to facilitate widespread usage of the inventive system through existing pharmacy networks, the unique identifier is a numeric representation may be simply typed or otherwise entered into an existing pharmacy system for entering and processing secondary insurance-type information for prescriptions.

In an alternate embodiment, a patient is given the point of contact (phone, web, mail, etc.) in order to opt-in to a follow up program that offers supplemental incentives (e.g. additional benefits such as disease management information, updates, etc). In such a case where a patient consents to enrolling in the follow up program, his name, address, indication of consent, preferred means of receiving future reminders, and other information can be received through mail, email, or via phone, by a customer service processor such as an opt-in center into a database (not depicted) (either through manual data entry input, or through form-based scanning as known in the art).

When the card is presented at the pharmacy the system is already provided with a way of correlating information based on the confidential identification number being identifiable from a grouping of codes that have been assigned so that when sample redemption cards 3 are supplied by pharmaceutical sales representatives to physicians, a specific range of confidential identification numbers will be known to have been assigned to a given physician at 6 at the time of card distribution. When provisioned as such, usage by patients thereafter at pharmacy, will provide a way to be able to correlate the entirety of patient information received by customer service processor with the confidential identification number that will accompany the transmission of the occurrence of a prescription transaction being fulfilled at pharmacy by a given patient. Storing the information according to a confidential number limits the unnecessary transmitting of private patient health information that might be prohibited under HIPAA and other privacy regulations, yet allows for subsequent program participation by offering a toll free number or other means, along with supplemental incentives such as on-going free disease management information, etc. for inducing patient opt-in. A participating pharmacy need not concern itself with patient consent, as it transmits only the date and time stamped transaction containing the confidential identification number associated with the transaction. Ideally, a pharmacy and customer service processor will be connected to each other via some form of network means, such as the internet, where they can communicate in real time as needed, or where they can just send coded transaction data and reimbursement information data to each other as needed through regularized, instant transmission of transaction data.

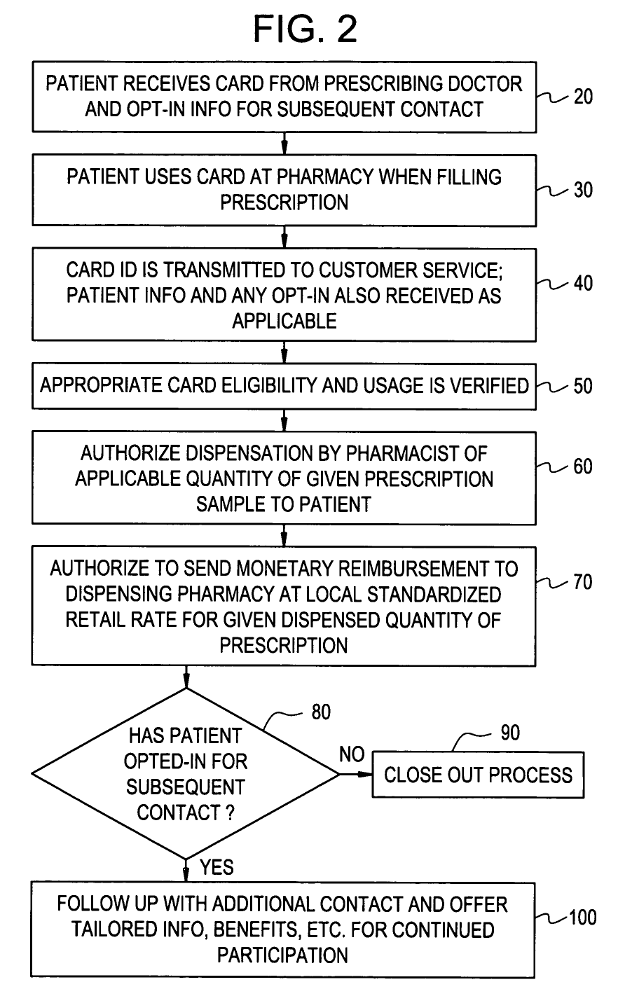

A more specific illustration is depicted in FIG. 2. In a preferred process within the inventive system, a patient's doctor already inclined to carry around the compact wallet 1, when writing a prescription, would hand his patient an attached sample redemption card 3 at 20 which the doctor is inclined to carry with him on a daily basis, given the compact design and convenient, useful features. The patient, ideally motivated by the idea of incentives (e.g., the free medication sample stated herein), together with his physician's recommendation, will therefore be inclined to participate in prescription fulfillment. Thus, the patient provides the card 3 to the pharmacist when filling his prescription. The card identification (e.g. confidential number) is keyed or scanned into and transmitted to the customer service processor at 30 in order that the system may provide the discounts to patient and reimbursements and any participation fees to participants, such as the pharmacy. The confidential identification number from card 3 can be formed as a time and date-stamped data packet, and can be sent to the customer service processor via a network, instantly through an established communication link such as satellite, frame relay, PSTN, LAN or WAN or POTS, and in an especially preferred embodiment, would be a dedicated T2 type or better, or satellite connection, and could be downloaded in real time. The following data might then be received at the customer service processor; prescription number; dosage amount; drug type; and date billed and based on this, the process would be able to verify participation eligibility at 40. Thereafter, the free sample can be authorized for dispensing at 60, and the appropriate, agreed-upon reimbursement can be sent or credited immediately against future wholesale purchases by the pharmacy. From the confidential identification number received in each transaction, the customer service processor could correlate the date and time of the prescription being filled with the confidential identification number. Thus, the confidential identification number would enable the correlation by enabling a retrieval of the primary care giver name, address and phone number; patient name. Where there is a recognition of the patient having an opt-in, (either now or later, by toll free number, email, etc. as indicated on card 3,) then notification may occur through the preferred notification methodology (internet, cellular or land line phone number, pager, mail etc. as indicated when opting in) based on the proof of consent that already resides in the database at customer service processor after the patient has communicated his consent.

In one alternative embodiment, instead of in-person presentation at a pharmacy, the present invention provides for card 3 to be used over the phone or through the mail as is currently popular when filling prescriptions. In such cases, rather than utilizing a scan, the confidential identification number, or other number such as the a bar code number or other serial number that represents the confidential identification number, may be written down on a refill form for mailing to customer service processor, input on a web page form on the internet for transmission to customer service processor, or may be communicated over the phone to a live representative or to a voice activated automated system at customer service processor. The cost of the free sample could be accounted for by the automated system of the customer service center when payment is required during the transaction.

Conversely, if the refill has not been processed according to a set of terms associated with a patient's particular prescription need, (e.g., within the refill time period), then dates of compliance or non-compliance, as well as caregiver notification might, in certain embodiments, may be recorded in a database at the customer service processor. Thereafter, information regarding patient compliance may be aggregated (to preserve anonymity for privacy concerns) to form broad pictures of compliance by groupings of patients. Such compliance might then be given to physician as doctor-specific feedback or other type of an informational representation of doctor's patient base compliance. Provision of such information in this manner would not only be HIPAA-compliant, but would also be useful to physicians in improving or understanding their own practice and/or patient base, as well as for insurance and/or pharmaceutical business purposes.

This application—taken as a whole with the specification, claims, abstract, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure. Modification of this method and apparatus can become clear to a person having ordinary skill in this particular art; all such modifications are clearly covered by this disclosure.

What I claim is:

1. A prescription sample means and pad wallet system for the inducement of participation in a compliance system comprising:
(a) a compact foldable wallet having at least a foldable spine and at least two leaves, said at least two leaves comprising a front leaf and a back leaf, each attached to said foldable spine;
(b) at least one prescription sample means having a confidential identification number; said prescription sample means being attached to one of said leaves for activating a patient participation record related to said confidential identification number; and
(c) a personalized physician pad attached to one of said leaves.

2. The solicitation means of claim 1, further comprising:
a solicitation means, associated with each said reusable discount means, for soliciting a patient consent and patient information.

3. The system of claim 2, wherein said confidential identification number allows collection of information representing said prescription compliance of at least one patient participation record for medical purposes.

4. The system of claim 3, wherein said medical purposes includes a doctor-specific feedback on patients.

5. The system of claim 4, wherein said incentive further includes a monetary payment to a pharmacy in response to said receipt of said prescription fulfillment by said processor means.

6. A method of encouraging prescription drug compliance by offering incentives, said method comprising:
(a) assigning a confidential identification number to a reusable discount means;
(b) recording said confidential identification number associated with a respective reusable discount means;
(c) issuing said reusable discount means in a convenient wallet pad combination for the fostering of distribution to a patient having a prescription need;
(d) receiving a patient prescription fulfillment associated with said confidential identification number;
(e) offering, via a pharmacy, a prescription sample need to said patient; and
(f) reimbursing said pharmacy by offering a monetary benefit to said pharmacy for filling a prescription sample offering.

7. The method of claim 6, further comprising the step of:
obtaining a patient consent and patient information assorted with said prescription need by offering of supplemental incentives to said patient.

8. The method of claim 7, wherein said reimbursements to said pharmacy are credits on a price assigned to a given prescription wholesale procurement, and wherein said credits are immediately available to said pharmacy at time of prescription fulfillment.

9. The method of claim 8, further comprising the step of collecting a set of patient data based upon said patient compliance record and said patient information for medical purposes, based on a patient opt-in preference.

10. The method of claim 9, wherein said step of collecting said set of patient data for medical purposes comprises further includes the step of aggregating said patient data for delivery to a doctor associated with the patient data.
